(19) United States
(12) Patent Application Publication
(10) Pub. No.: US 2023/0317350 A1
(43) Pub. Date: Oct. 5, 2023

(54) COIL COMPONENT

(71) Applicant: Murata Manufacturing Co., Ltd., Kyoto-fu (JP)

(72) Inventors: Kozo SATO, Nagaokakyo-shi (JP); Minoru GIBU, Nagaokakyo-shi (JP)

(73) Assignee: Murata Manufacturing Co., Ltd., Kyoto-fu (JP)

(21) Appl. No.: 18/184,579

(22) Filed: Mar. 15, 2023

(30) Foreign Application Priority Data
Mar. 30, 2022 (JP) 2022-057181

(51) Int. Cl. H01F 27/28; H01F 1/24; H01F 5/06; H01F 27/29; H01F 27/02

(52) U.S. Cl. CPC H01F 27/2804; H01F 1/24; H01F 5/06; H01F 27/29; H01F 27/022; H01F 2027/2809

(57) ABSTRACT

A coil component that is a multilayer coil component includes an element assembly containing a magnetic material, a coil embedded in the element assembly, an outer electrode electrically coupled to the coil and disposed on a bottom surface of the element assembly, and an insulating layer disposed on the bottom surface of the element assembly. The insulating layer has a cavity, and the outer electrode is disposed in the cavity.

### CROSS-REFERENCE TO RELATED APPLICATION

This application claims benefit of priority to Japanese Patent Application No. 2022-057181, filed Mar. 30, 2022, the entire content of which is incorporated herein by reference.

### BACKGROUND

### Technical Field

The present disclosure relates to a coil component.

### Background Art

A known multilayer coil component includes a magnetic portion containing a metal magnetic powder. Regarding such a multilayer coil component, since the metal magnetic powder contained in the magnetic portion is an electrically conductive particle composed of iron and the like, there is a concern that extension of plating may occur. In this regard, it is known that an insulation coating having high insulation resistance is applied to an upper surface and a lower surface to ensure the insulation performance of the surface (Japanese Unexamined Patent Application Publication No. 2013-254917).

Regarding the multilayer coil component described in Japanese Unexamined Patent Application Publication No. 2013-254917, since the insulation coating is applied to the upper surface and the lower surface, a size reduction and a profile reduction are difficult.

### SUMMARY

Accordingly, the present disclosure provides a coil component having an advantage in the size reduction and the profile reduction due to extension of plating being suppressed from occurring.

The present disclosure includes the following aspects.

(1) A coil component that is a multilayer coil component including an element assembly containing a magnetic material, a coil embedded in the element assembly, an outer electrode electrically coupled to the coil and disposed on a bottom surface of the element assembly, and an insulating layer disposed on the bottom surface of the element assembly. The insulating layer has a cavity, and the outer electrode is disposed in the cavity.

(2) The coil component according to (1) above, wherein the outer electrode includes a bottom surface electrode and a plating layer disposed on the bottom surface electrode.

(3) The coil component according to (2) above, wherein the bottom surface electrode is disposed in the element assembly, and the plating layer is disposed in the cavity.

(4) The coil component according to any one of (1) to (3) above, wherein the area of the cavity is less than or equal to the area of the bottom surface electrode in plan view when viewed from the bottom surface side of the element assembly.

(5) The coil component according to any one of (1) to (4) above, wherein the plating layer is disposed flush with the insulating layer.

(6) The coil component according to any one of (1) to (4) above, wherein the plating layer is recessed on the bottom surface of the insulating layer.

(7) The coil component according to any one of (1) to (4) above, wherein the plating layer is disposed protruding from the insulating layer.

(8) The coil component according to any one of (1) to (7) above, wherein the plating layer is a Cu layer, a Ni—Sn layer, a Ni—Au layer, a Ni—Cu layer, or a Cu—Ni—Au layer.

(9) The coil component according to any one of (1) to (8) above, wherein the insulating layer is a resin material having larger insulation resistance than the element assembly.

(10) The coil component according to any one of (1) or (9) above, wherein the magnetic material contains a metal magnetic particle.

(11) A method for manufacturing a coil component that is a multilayer coil component including an element assembly containing a magnetic material, a coil embedded in the element assembly, an outer electrode electrically coupled to the coil and disposed on a bottom surface of the element assembly, and an insulating layer disposed on the bottom surface of the element assembly. The method includes producing a multilayer body block by including a magnetic paste layer and a conductor paste layer, stacking a conductor paste layer serving as a bottom surface electrode on the bottom surface, and performing firing, forming an insulating layer having a cavity for exposing at least a portion of the bottom surface electrode region on the surface at which the bottom surface electrode is exposed of the fired multilayer body block, forming a plating layer on the bottom surface electrode in the cavity, and cutting the multilayer body block.

According to the present disclosure, an outer electrode being formed in a cavity of an insulating layer suppresses extension of plating from occurring and enables a coil component having an advantage in a size reduction and a profile reduction to be provided.

### BRIEF DESCRIPTION OF THE DRAWINGS

FIG. 1 is a schematic perspective view illustrating a multilayer coil component 1 according to a first embodiment of the present disclosure;

FIG. 2 is a schematic sectional view illustrating a cross section of the multilayer coil component 1 cut along line II-II in FIG. 1;

FIG. 3 is a schematic sectional view illustrating a cross section of the multilayer coil component 1 cut along line in FIG. 1;

FIG. 4 is a schematic sectional view illustrating a cross section of the multilayer coil component 1 cut along line IV-IV in FIG. 1;

FIG. 5 is a schematic sectional view illustrating a cross section of the multilayer coil component 1 cut along line V-V in FIG. 1;

FIG. 6 is a schematic bottom view of the multilayer coil component 1 in FIG. 1;

FIGS. 7A to 7J are diagrams illustrating a method for manufacturing the multilayer coil component 1 in FIG. 1; and

FIGS. 8A to 8C are diagrams illustrating a method for manufacturing the multilayer coil component 1 in FIG. 1.

### DETAILED DESCRIPTION

A coil component according to the present disclosure will be described below in detail with reference to the drawings. However, the coil component according to the present disclosure and the shapes, the arrangements, and the like of constituent elements are not limited to the examples illustrated. In the drawings, members having the same function may be indicated by the same reference. In consideration of ease of explanations or understanding of important points, some embodiments will be described for the sake of convenience. However, configurations described in different embodiments can be partly replaced or combined with each other. Regarding an embodiment described after another embodiment, explanations of matters common to the former embodiment may be omitted, and only different points may be explained. In particular, the same operation and advantage due to the same configuration are not limited to be described one by one on an embodiment basis. The size, the positional relationship, and the like of members illustrated in the drawings may be exaggerated to clarify the explanations.

### First Embodiment

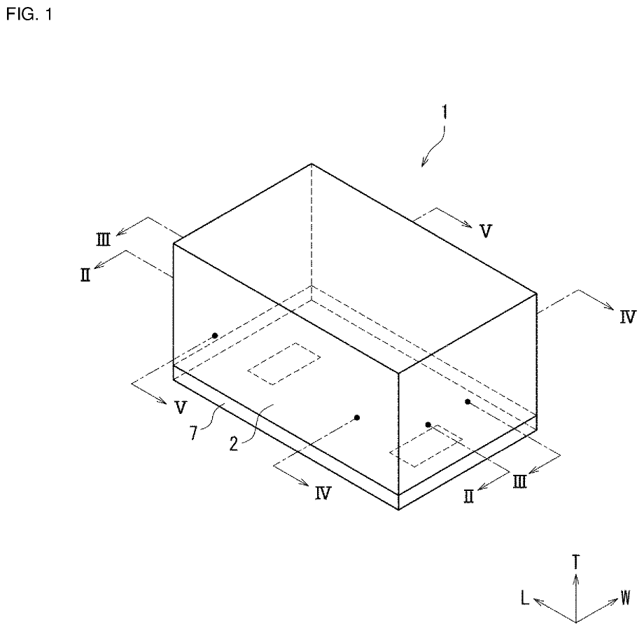

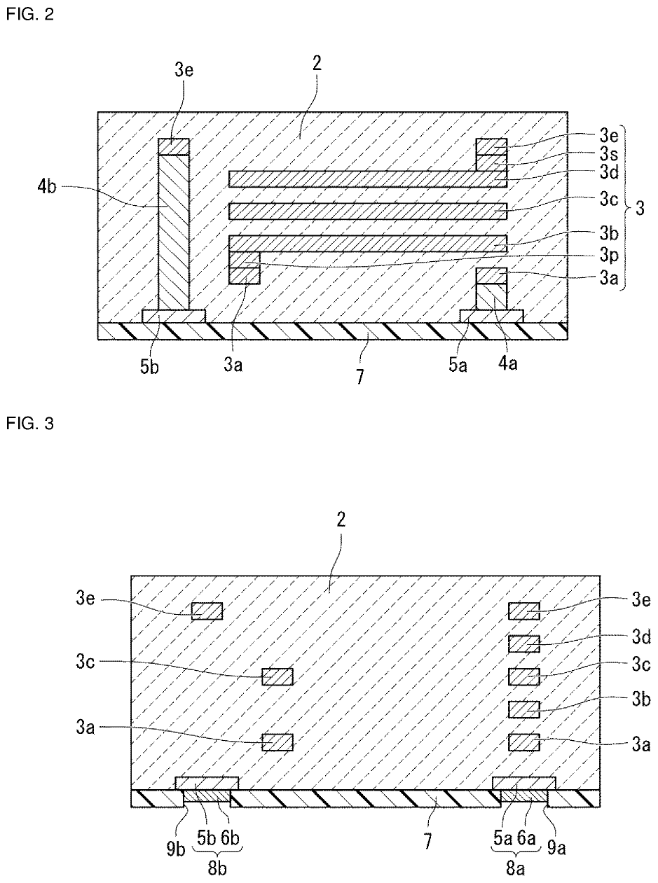

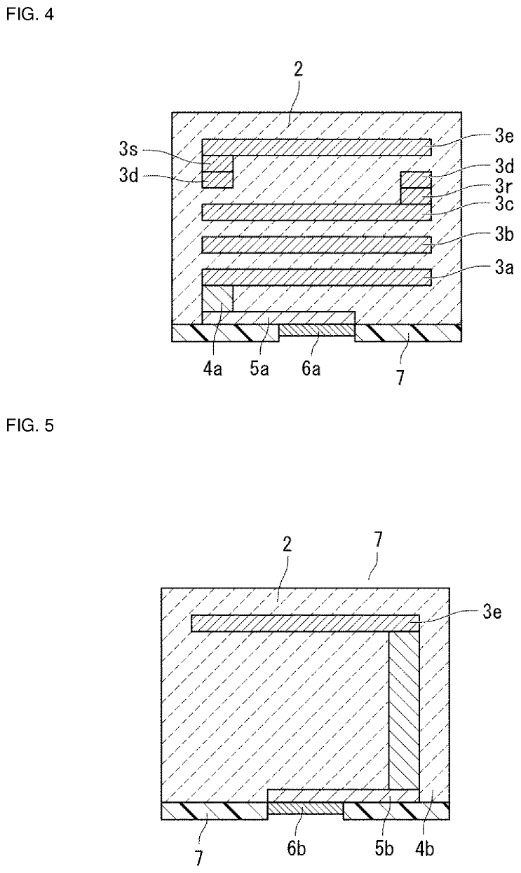

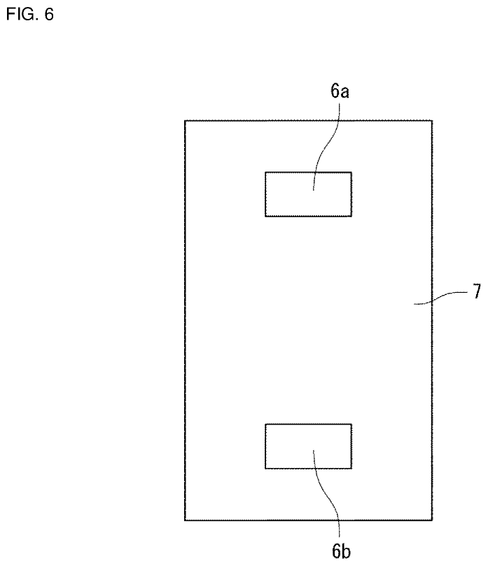

FIG. 1 is a perspective view illustrating a multilayer coil component 1 according to the present embodiment, and FIG. 6 is a bottom view. In addition, FIG. 2 is a schematic sectional view of the multilayer coil component 1 cut along line II-II, FIG. 3 is a schematic sectional view cut along line FIG. 4 is a schematic sectional view cut along line IV-IV, and FIG. 5 is a schematic sectional view cut along line V-V.

As illustrated in FIG. 1 to FIG. 6, the multilayer coil component 1 according to the present embodiment has a substantially rectangular parallelepiped shape. In this regard, in FIG. 1, a lower surface is denoted as a bottom surface, an upper surface is denoted as a top surface, and other surfaces are denote as side surfaces. The multilayer coil component 1 roughly includes an element assembly 2, a coil 3 embedded in the element assembly 2, outer electrodes 8a and 8b, and an insulating layer 7 for covering a bottom surface of the element assembly 2. The insulating layer 7 has cavities 9a and 9b. The outer electrodes 8a and 8b are present in the cavities 9a and 9b, respectively. The coil 3 is formed from a plurality of inner electrode layers 3a to 3e being connected to each other with via conductors 3p to 3s interposed therebetween. The outer electrodes 8a and 8b include bottom surface electrodes 5a and 5b located inside the element assembly 2 and plating layers 6a and 6b disposed on the bottom surface electrodes 5a and 5b and located in the cavities 9a and 9b. The outer electrodes 8a and 8b are electrically coupled to both ends of the coil 3 with the extended portions 4a and 4b, respectively, interposed therebetween.

The coil component according to the present disclosure preferably has a length (L) of 1.0 mm or more and 6.0 mm or less (i.e., from 1.0 mm to 6.0 mm), a width (W) of 0.2 mm or more and 2.0 mm or less (i.e., from 0.2 mm to 2.0 mm), and a height (T) of 0.2 mm or more and 2.0 mm or less (i.e., from 0.2 mm to 2.0 mm) and more preferably has a length of 1.0 mm or more and 2.0 mm or less (i.e., from 1.0 mm to 2.0 mm), a width of 0.5 mm or more and 1.2 mm or less (i.e., from 0.5 mm to 1.2 mm), and a height of 0.5 mm or more and 1.2 mm or less (i.e., from 0.5 mm to 1.2 mm).

In the present embodiment, the element assembly 2 includes a magnetic layer containing a magnetic material.

The magnetic material is typically a metal magnetic particle.

There is no particular limitation regarding a metal magnetic material constituting the metal magnetic particle provided that the material has magnetism, and examples include iron, cobalt, nickel, and gadolinium and alloys containing at least one of these metals. It is preferable that the metal magnetic material be iron or an iron alloy. The iron may be just iron or be an iron derivative, for example, a complex. There is no particular limitation regarding the iron derivative, and examples include iron carbonyls, which are complexes of iron and CO, and preferably include iron pentacarbonyl. In particular, a hard-grade iron carbonyl (for example, a hard-grade iron carbonyl produced by BASF) having an onion skin structure (structure in which concentric-sphere-shaped layers are formed around the center of a particle) is preferable. There is no particular limitation regarding the iron alloy, and examples include Fe—Si-based alloys, Fe—Si—Cr-based alloys, and Fe—Si—Al-based alloys. The above-described alloy may further contain B, C, and the like as other secondary components. There is no particular limitation regarding the content of the secondary component. For example, the content may be 0.1% by mass or more and 5.0% by mass or less (i.e., from 0.1% by mass to 5.0% by mass) and preferably 0.5% by mass or more and 3.0% by mass or less (i.e., from 0.5% by mass to 3.0% by mass). The metal magnetic material may be only one type or two or more types.

In a preferred aspect, the metal magnetic material is an Fe—Si-based alloy or an Fe—Si—Cr-based alloy. When an Fe—Si-based alloy is used as the metal magnetic powder, the Si content is preferably 2.0 at % or more and 8.0 at % or less (i.e., from 2.0 at % to 8.0 at %). When an Fe—Si—Cr-based alloy is used, the Si content is preferably 2.0 at % or more and 8.0 at % or less (i.e., from 2.0 at % to 8.0 at %), and the Cr content is preferably 0.2 at % or more and 6.0 at % or less (i.e., from 0.2 at % to 6.0 at %).

The metal magnetic particle may contain impurity components such as Cr, Mn, Cu, Ni, P, and S. These impurity components are unintentionally included, and the content thereof may be, for example, 1% by mass or less and preferably 0.1% by mass or less.

The metal magnetic particle has an average particle diameter of preferably 0.5 μm or more and 50 μm or less (i.e., from 0.5 μm to 50 μm), more preferably 1 μm or more and 30 μm or less (i.e., from 1 μm to 30 μm), and further preferably 2 μm or more and 20 μm or less (i.e., from 2 μm to 20 μm). Setting the average particle diameter of the metal magnetic particle to be 0.5 μm or more facilitates handling of the metal magnetic particle. In addition, setting the average particle diameter of the metal magnetic particle to be 50 μm or less enables the filling ratio of the metal magnetic particle to be increased so that the magnetic characteristics of the magnetic layer are improved.

In this regard, the average particle diameter denotes an average of the equivalent circle diameters of metal magnetic particles in an SEM (scanning electron microscope) image of a cross section of the magnetic layer. For example, the average particle diameter can be obtained by taking SEM images of a plurality of (for example, five) regions (for example, 130 μm x 100 μm) in a cross section obtained by cutting the multilayer coil component 1, analyzing the resulting SEM images by using image analysis software (for example, Azokun (registered trademark) produced by Asahi Kasei Engineering Corporation) so as to determine the equivalent circle diameters of 500 or more metal particles, and calculating the average thereof.

The metal magnetic particle has preferably an oxide film.

The oxide film may be an oxide film of a metal constituting the metal magnetic particle.

There is no particular limitation regarding the thickness of the oxide film. The thickness is preferably 1 nm or more and 100 nm or less (i.e., from 1 nm to 100 nm), more preferably 3 nm or more and 50 nm or less (i.e., from 3 nm to 50 nm), and further preferably 5 nm or more and 30 nm or less (i.e., from 5 nm to 30 nm) and, for example, may be 10 nm or more and 30 nm or less (i.e., from 10 nm to 30 nm) or may be 5 nm or more and 20 nm or less (i.e., from 5 nm to 20 nm). Increasing the thickness of the oxide film improves the specific resistance of the magnetic layer. In addition, decreasing the thickness of the oxide film enables the amount of the metal magnetic particle in the magnetic layer to be increased, improves the magnetic characteristics of the magnetic layer, and facilitates a size reduction of the magnetic layer.

The metal magnetic particles are bonded by the oxide film.

The metal magnetic particle may be insulation-coated with an insulating film. The insulating film may be a film other than the above-described oxide film.

The insulating film is preferably a film containing an metal oxide and more preferably a Si oxide film.

Examples of the method for forming the insulating film include a mechanochemical method and a sol-gel method. In particular, when a Si oxide film is formed, the sol-gel method is preferably used. When a film containing the Si oxide is formed by using the sol-gel method, the film can be formed by mixing a sol-gel coating agent containing Si alkoxide and an organic-chain-containing silane coupling agent, attaching the resulting liquid mixture to the surface of the metal magnetic particle, performing heating treatment so as to cause dehydration bonding, and performing drying at a predetermined temperature.

The insulating film may cover only a portion of the surface of the metal magnetic particle or may cover the entire surface. In this regard, there is no particular limitation regarding the shape of the insulating film, and the shape may be a mesh or a layer. In a preferred aspect, a region covered by the insulating film is 50% or more, preferably 70% or more, more preferably 80% or more, further preferably 90% or more, and particularly preferably 100% the surface of the metal magnetic particle. The surface of the metal particle being covered with the insulating film enables the specific resistance of the interior of the magnetic layer to be increased.

There is no particular limitation regarding the thickness of the insulating film. The thickness is preferably 1 nm or more and 100 nm or less (i.e., from 1 nm to 100 nm), more preferably 3 nm or more and 50 nm or less (i.e., from 3 nm to 50 nm), and further preferably 5 nm or more and 30 nm or less (i.e., from 5 nm to 30 nm) and, for example, may be 10 nm or more and 30 nm or less (i.e., from 10 nm to 30 nm) or may be 5 nm or more and 20 nm or less (i.e., from 5 nm to 20 nm). Increasing the thickness of the insulating film enables the specific resistance of the interior of the magnetic layer to be increased. In addition, decreasing the thickness of the insulating film enables the amount of the metal magnetic particle in the magnetic layer to be increased, improves the magnetic characteristics of the magnetic layer, and facilitates a size reduction of the magnetic layer.

The element assembly 2 may include a nonmagnetic layer in addition to the magnetic layer.

The nonmagnetic layer is disposed preferably between inner electrode layers.

The nonmagnetic layer being disposed improves the direct-current superimposition characteristics of the multilayer coil component and improves the insulation performance between the inner electrodes.

The nonmagnetic layer is preferably composed of a sintered nonmagnetic material containing at least Fe, Cu, and Zn as primary components.

In the sintered nonmagnetic material, the Fe content may be preferably 40.0% by mol or more and 49.5% by mol or less (i.e., from 40.0% by mol to 49.5% by mol) (relative to the total amount of the primary components, the same applies hereafter) and more preferably 45.0% by mol or more and 49.5% by mol or less (i.e., from 45.0% by mol to 49.5% by mol) in terms of Fe₂O₃.

In the sintered nonmagnetic material, the Cu content is preferably 4.0% by mol or more and 12.0% by mol or less (i.e., from 4.0% by mol to 12.0% by mol) (relative to the total amount of the primary components, the same applies hereafter) and more preferably 6.0% by mol or more and 10.0% by mol or less (i.e., from 6.0% by mol to 10.0% by mol) in terms of CuO.

In the sintered nonmagnetic material, there is no particular limitation regarding the Zn content, and the content may be the result of subtracting the content of Fe and Cu which are other primary components from the content of the primary components and may be preferably 39.5% by mol or more and 56.0% by mol or less (i.e., from 39.5% by mol to 56.0% by mol) (relative to the total amount of the primary components, the same applies hereafter) and more preferably 40.5% by mol or more and 49.0% by mol or less (i.e., from 40.5% by mol to 49.0% by mol) in terms of ZnO.

Setting the contents of Fe, Cu, and Zn to be within the above-described ranges enables excellent electric characteristics to be obtained.

In the present disclosure, the sintered nonmagnetic material may further contain an additive component. Examples of the additive component in the sintered nonmagnetic material include Mn, Co, Sn, Bi, and Si and are not limited to these. The content (amount of addition) of each of Mn, Co, Sn, Bi, and Si relative to 100 parts by mass of the total primary components (Fe (in terms of Fe₂O₃), Zn (in terms of ZnO), Cu (in terms of CuO), and Ni (in terms of NiO)) is preferably 0.1 parts by mass or more and 1 part by mass or less (i.e., from 0.1 parts by mass to 1 part by mass) in terms of Mn₃O₄, Co₃O₄, SnO₂, Bi₂O₃, and SiO₂, respectively. In this regard, the sintered nonmagnetic material may further contain impurities incidental to the production.

The thickness of the nonmagnetic layer may be preferably 5 μm or more and 180 μm or less (i.e., from 5 μm to 180 μm), more preferably 10 μm or more and 100 μm or less (i.e., from 10 μm to 100 μm), and further preferably 30 μm or more and 100 μm or less (i.e., from 30 μm to 100 μm).

The coil 3 is formed from a plurality of inner electrode layers 3a to 3e being connected to each other with via conductors 3p to 3s interposed therebetween.

The inner electrode layer contains an electrically conductive material. The electrically conductive material includes silver, copper, or gold or an alloy thereof. The inner electrode layer preferably contains silver as the electrically conductive material and more preferably contains just silver.

There is no particular limitation regarding the thickness of the inner electrode layer, and the thickness is preferably 15 μm or more and 150 μm or less (i.e., from 15 μm to 150 μm) and more preferably 20 μm or more and 40 μm or less (i.e., from 20 μm to 40 μm).

The extended portions 4a and 4b electrically couple the ends of the coil 3 to the bottom surface electrodes 5a and 5b. In the present embodiment, the extended portion 4a couples the inner electrode layer 3a at the coil lower end to the bottom surface electrode 5a, and the extended portion 4b couples the inner electrode layer 3e at the coil upper end to the bottom surface electrode 5b. The extended portion 4b is longer than the extended portion 4a.

The extended portions 4a and 4b preferably contain the electrically conductive material akin to that of the inner electrode layer. The electrically conductive material includes silver, copper, or gold or an alloy thereof. The extended portions 4a and 4b preferably contain silver as the electrically conductive material and more preferably contain just silver.

The insulating layer 7 is disposed on the bottom surface of the element assembly 2.

In the multilayer coil component 1, the insulating layer 7 is disposed on only the bottom surface. In other words, the insulating layer 7 is not present on the top surface nor the side surfaces of the element assembly 2. Regarding the coil component according to the present disclosure, such an aspect is preferable but the coil component is not limited to this. For example, the insulating layer may also be disposed on the side surfaces or side surfaces and the top surface in addition to the bottom surface.

The insulating layer 7 has cavities 9a and 9b.

The cavities 9a and 9b are formed so as to expose the bottom surface electrodes 5a and 5b. At the cavity, preferably, only the bottom surface electrode is exposed, and the element assembly 2 is not exposed. In other words, in plan view of the element assembly 2 when viewed from the bottom surface side, the area of the cavities 9a and 9b is less than or equal to the area of the bottom surface electrodes 5a and 5b, and the cavities 9a and 9b are located inside the bottom surface electrodes 5a and 5b. The cavity being formed so as not to expose the element assembly 2 enables extension of plating due to contact of a plating liquid with the element assembly 2 to be suppressed from occurring during a plating step of forming a plating layer.

The insulating layer 7 is composed of a resin material having larger insulation resistance than the material for forming the element assembly 2.

Examples of the resin material include resin materials having high electrical insulation performance, such as acrylic resins, epoxy-based resins, and polyamides. In this regard, the resin material may include a filler formed of an insulating material.

The outer electrodes 8a and 8b are disposed on the bottom surface of the multilayer coil component 1. The outer electrodes 8a and 8b include bottom surface electrodes 5a and 5b and the plating layers 6a and 6b disposed on the bottom surface electrodes 5a and 5b. The bottom surface electrodes 5a and 5b are disposed in the element assembly 2, and the plating layers 6a and 6b are disposed in the cavities 9a and 9b.

In the multilayer coil component 1, the bottom surface electrodes 5a and 5b are embedded in the element assembly 2 while a main surface is exposed at the element assembly 2. In this regard, the coil component according to the present disclosure is not limited to such an aspect. For example, only a portion of the bottom surface electrode may be embedded in the element assembly, or the bottom surface electrode may be disposed on the bottom surface of the element assembly.

In the multilayer coil component 1, the bottom surface electrodes 5a and 5b extend from the extended portions 4a and 4b to the substantially central portion of the element assembly 2 in the W-direction on the bottom surface of the element assembly 2. In this regard, the coil component according to the present disclosure is not limited to such an aspect. For example, the bottom surface electrode may be disposed at the same position as the position of the extended portion.

The bottom surface electrodes 5a and 5b preferably contain the electrically conductive material akin to that of the inner electrode layer. The electrically conductive material includes silver, copper, or gold or an alloy thereof. The bottom surface electrodes 5a and 5b preferably contain silver as the electrically conductive material and more preferably contain just silver.

The plating layers 6a and 6b are disposed on the bottom surface electrodes 5a and 5b in the cavities 9a and 9b. The plating layer is preferably disposed in the entire cavity in plan view of the element assembly 2 when viewed from the bottom surface side.

In the multilayer coil component 1, the thickness of the plating layers 6a and 6b (length in the T-direction) is less than the height (length in the T-direction) of the cavities 9a and 9b. That is, the plating layers 6a and 6b are recessed on the bottom surface of the insulating layer 7. In other words, the multilayer coil component 1 has a recessed portion delimited by the side surface of the cavity and the plating layer on the bottom surface. In this regard, the coil component according to the present disclosure is not limited to such an aspect. For example, the cavity may be completely filled with the plating layer. In an aspect, the plating layer may be disposed flush with the insulating layer. In another aspect, the plating layer may be disposed protruding from the insulating layer.

The plating layers 6a and 6b may be composed of a single layer or a plurality of layers.

The plating layers 6a and 6b may include preferably a plating layer containing Cu, a plating layer containing Ni, a plating layer containing Sn, or a plating layer containing Au.

In an aspect, the plating layers 6a and 6b may be a Cu plating layer, a Ni—Sn plating layer, a Ni—Au plating layer, a Ni—Cu plating layer, or a Cu—Ni—Au plating layer on the bottom surface electrode.

The multilayer coil component according to the present disclosure is described above with reference to the embodiment, but the multilayer coil component according to the present disclosure is not limited to the embodiment above and can be variously modified.

Next, a method for manufacturing the multilayer coil component according to the present disclosure will be described.

The multilayer coil component according to the present disclosure can be obtained by stacking a magnetic paste, a nonmagnetic paste, and an inner conductor paste and heat-treating the resulting material.

Specifically, the multilayer coil component 1 can be produced as described below.

Regarding the magnetic paste, a magnetic paste including a metal magnetic particle is prepared. The magnetic paste is obtained by mixing and kneading the metal magnetic particle with a mixture of cellulose, polyvinyl butyral, or the like serving as a binder and terpineol, butyl diglycol acetate, or the like serving as a solvent.

Regarding the nonmagnetic paste, a nonmagnetic paste containing a ferrite material is prepared. Fe₂O₃, ZnO, and CuO serving as ferrite materials and an additive component, as the situation demands, are weighed so as to form a predetermined composition, the weighed material and pure water, a dispersing agent, and PSZ media are placed into a ball mill, and mixing and pulverization are performed. The resulting slurry is dried and calcined under the condition of a temperature of 700° C. to 800° C. and 2 to 3 hours. The resulting nonmagnetic ferrite material (calcined powder) is mixed with a predetermined amount of a solvent (a ketone-based solvent or the like), a resin (a polyvinyl acetal or the like), and a plasticizer (an alkyd-based plasticizer or the like), kneaded by using a planetary mixer, and dispersed by using a three-roll mill so as to produce a nonmagnetic ferrite paste.

Regarding the conductor paste, a conductor paste, for example, a silver paste, is prepared. The conductor paste is obtained by mixing a conductor powder with a predetermined amount of a solvent, a resin, a dispersing agent, and the like.

Next, a multilayer body of the above-described pastes is produced.

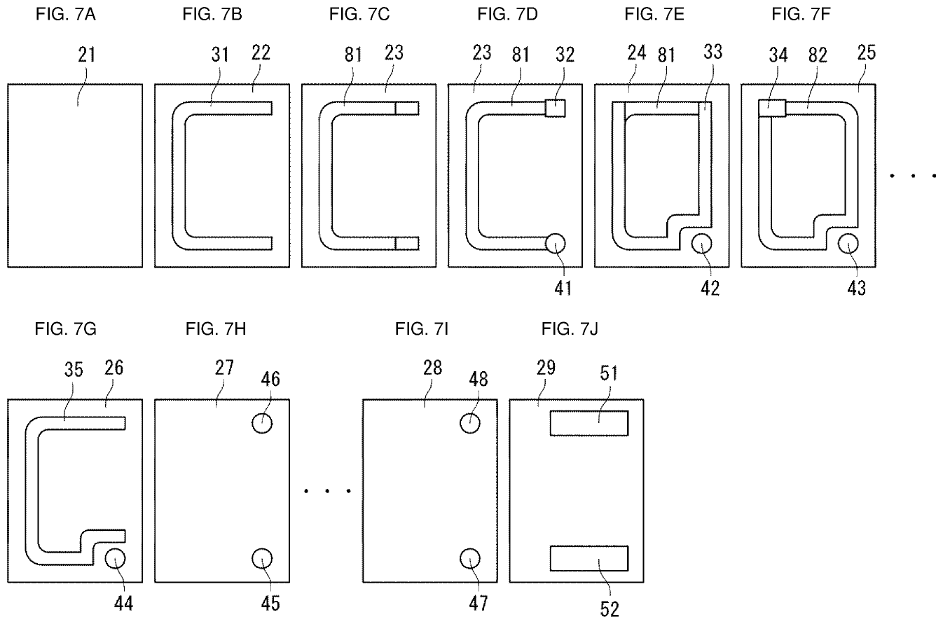

A substrate (not illustrated in the drawing) in which a thermally peelable sheet and a polyethylene terephthalate (PET) film are stacked on a metal plate is prepared, and the magnetic paste is applied thereto by performing predetermined times of screen printing so as to form a magnetic paste layer 21. The resulting magnetic paste layer 21 serves as an outer layer of a coil component (FIG. 7A).

A conductor paste layer 31 serving as a coil conductor is formed on the magnetic paste layer 21. Further, a magnetic paste layer 22 is formed in a region in which the conductor paste layer 31 is not formed (FIG. 7B).

A nonmagnetic ferrite paste layer 81 is formed in a region other than a region to be connected to a coil conductor applied next and a region to be connected to an extended conductor on the conductor paste layer 31. Subsequently, a magnetic paste layer 23 is formed in regions other than the nonmagnetic ferrite paste layer 81 (FIG. 7C).

A conductor paste layer 32 serving as a via conductor (a conductor to be connected to a coil conductor applied next) and a conductor paste layer 41 serving as an extended conductor are formed (FIG. 7D).

A conductor paste layer 33 serving as a coil conductor and a conductor paste layer 42 serving as an extended conductor are formed. Further, a magnetic paste layer 24 is formed in a region in which the conductor paste layers 33 and 42 are not formed (FIG. 7E).

A nonmagnetic ferrite paste layer 82 is formed in a region other than a region to be connected to a coil conductor applied next on the magnetic paste layer 33. In addition, a conductor paste layer 34 serving as a via conductor and a conductor paste layer 43 serving as an extended conductor are formed in regions to be connected to coil conductors applied next. Further, a magnetic paste layer 25 is formed in a region other than these regions (FIG. 7F).

The steps illustrated in FIG. 7E and FIG. 7F above are repeated predetermined times so as to obtain a multilayer body in which a magnetic paste layer 26, a conductor paste layer 35, and a conductor paste layer 44 are formed (FIG. 7G).

Conductor paste layers 45 and 46 are applied to portions serving as extended conductors, and a magnetic paste layer 27 is applied to a portion other than the above-described portions (FIG. 7H). This is repeated predetermined times so as to obtain a multilayer body in which a magnetic paste layer 28 and conductor paste layers 47 and 48 are formed (FIG. 7I).

Conductor paste layers 51 and 52 are formed in regions serving as bottom surface electrodes of the outer electrodes, and a magnetic paste layer 29 is formed in a region in which the conductor paste layers 51 and 52 are not formed (FIG. 7J).

Finally, the resulting multilayer body is peeled off the metal plate, the PET film is removed so as to produce a multilayer body block.

The resulting multilayer body block is subjected to pressurization treatment, for example, warm isostatic press (WIP) treatment.

The multilayer body block subjected to the pressurization treatment is degreased, placed into a furnace, and fired.

The firing temperature is preferably 600° C. or higher and 800° C. or lower (i.e., from 600° C. to 800° C.) and more preferably 650° C. or higher and 750° C. or lower (i.e., from 650° C. to 750° C.).

The firing time is preferably 30 min or more and 90 min or less (i.e., from 30 min to 90 min) and more preferably 40 min or more and 80 min or less (i.e., from 40 min to 80 min).

The firing is performed preferably in the air.

The multilayer body is impregnated with a resin after firing, and heat curing is performed. An epoxy resin is preferably used as the resin.

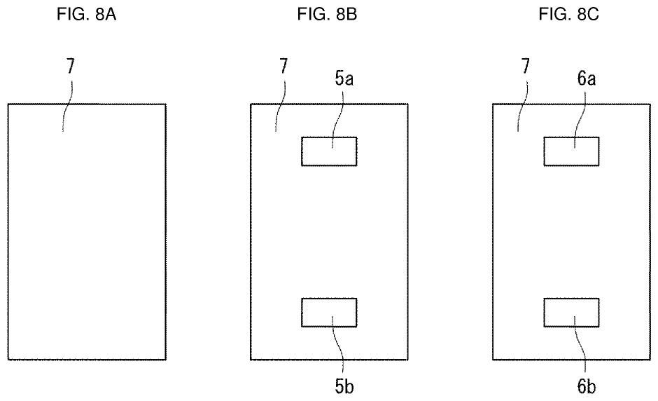

Regarding the multilayer body block subjected to resin impregnation, a photosensitive resist resin is applied by screen printing to the entire surface (lower surface) at which the bottom surface electrode is exposed and dried so as to obtain an insulating layer 7 (FIG. 8A).

After pattern exposure following the shape of the bottom surface electrode is performed, dipping into a developing liquid is performed so as to remove the insulating layer on the bottom surface electrode (FIG. 8B).

Electroless plating is performed so as to form plating layers on the bottom surface electrodes (FIG. 8C).

The multilayer body block is cut with a dicer or the like into individual pieces or arrays.

The multilayer coil component 1 can be obtained as described above.

The multilayer coil component according to the present disclosure may be widely used for various applications such as an inductor.

What is claimed is:

1. A coil component that is a multilayer coil component comprising:
an element assembly containing a magnetic material;
a coil embedded in the element assembly;
an outer electrode electrically coupled to the coil and disposed on a bottom surface of the element assembly; and
an insulating layer on the bottom surface of the element assembly,
wherein the insulating layer has a cavity, and the outer electrode is in the cavity.

2. The coil component according to claim 1, wherein
the outer electrode includes a bottom surface electrode and a plating layer on the bottom surface electrode.

3. The coil component according to claim 2, wherein
the bottom surface electrode is in the element assembly, and the plating layer is in the cavity.

4. The coil component according to claim 1, wherein
the area of the cavity is less than or equal to the area of the bottom surface electrode in plan view when viewed from the bottom surface side of the element assembly.

5. The coil component according to claim 1, wherein
the plating layer is flush with the insulating layer.

6. The coil component according to claim 1, wherein
the plating layer is recessed on the bottom surface of the insulating layer.

7. The coil component according to claim 1, wherein
the plating layer protrudes from the insulating layer.

8. The coil component according to claim 1, wherein
the plating layer is a Cu layer, a Ni—Sn layer, a Ni—Au layer, a Ni—Cu layer, or a Cu—Ni—Au layer.

9. The coil component according to claim 1, wherein
the insulating layer is a resin material having larger insulation resistance than the element assembly.

10. The coil component according to claim 1, wherein
the magnetic material contains a metal magnetic particle.

11. The coil component according to claim 2, wherein
the area of the cavity is less than or equal to the area of the bottom surface electrode in plan view when viewed from the bottom surface side of the element assembly.

12. The coil component according to claim 3, wherein
the area of the cavity is less than or equal to the area of the bottom surface electrode in plan view when viewed from the bottom surface side of the element assembly.

13. The coil component according to claim 2, wherein
the plating layer is flush with the insulating layer.

14. The coil component according to claim 3, wherein
the plating layer is flush with the insulating layer.

15. The coil component according to claim 2, wherein
the plating layer is recessed on the bottom surface of the insulating layer.

16. The coil component according to claim 2, wherein
the plating layer protrudes from the insulating layer.

17. The coil component according to claim 1, wherein
the plating layer is a Cu layer, a Ni—Sn layer, a Ni—Au layer, a Ni—Cu layer, or a Cu—Ni—Au layer.

18. The coil component according to claim 1, wherein
the insulating layer is a resin material having larger insulation resistance than the element assembly.

19. The coil component according to claim 1, wherein
the magnetic material contains a metal magnetic particle.

20. A method for manufacturing a coil component that is a multilayer coil component including an element assembly containing a magnetic material, a coil embedded in the element assembly, an outer electrode electrically coupled to the coil and disposed on a bottom surface of the element assembly, and an insulating layer on the bottom surface of the element assembly, the method comprising:
producing a multilayer body block by forming a conductor paste layer on a bottom surface of a multilayer body including a magnetic paste layer and a conductor paste layer, and performing firing;
forming an insulating layer having a cavity for exposing at least a portion of the bottom surface electrode region on the surface at which the bottom surface electrode is exposed of the fired multilayer body block;
forming a plating layer on the bottom surface electrode in the cavity; and
cutting the multilayer body block.
